(19) United States
(12) Patent Application Publication
(10) Pub. No.: US 2010/0090136 A1
(43) Pub. Date: Apr. 15, 2010

(54) PRESSURE VAVLE

(76) Inventors: Benjamin Daniel Barriga Garcia, Lohr (DE); Georg Schoppel, Lohr (DE)

Correspondence Address: MICHAEL J. STRIKER, 103 EAST NECK ROAD, HUNTINGTON, NY, 11743, US

(21) Appl. No.: 12/529,630

(22) PCT Filed: Mar. 19, 2008
(86) PCT No.: PCT/EP08/02197

§ 371 Date: Sep. 2, 2009

(30) Foreign Application Priority Data
Mar. 20, 2007 (DE) 10-2007-013-152.8

(51) Int. Cl. F16K 31/12

(52) U.S. Cl. 251/25; 251/318

(57) ABSTRACT

A pressure valve comprises a valve bush and a control plunger which is movably guided in the valve bush and enables a pressure medium path from a pressure medium source to a consumer via the valve bush to be controlled. A collar section is provided on the control plunger, via which the cross section of a radial opening of the valve bush on the side of the pressure medium source may be modified. The pressure medium path downstream of the radial opening is guided by at least one channel which extends axially through the collar section. The pressure valve also comprises a pilot control system which is used to apply an adjustable control pressure to the control plunger; a control pressure medium supply channel comprising an inlet opening is provided on the control plunger in a region upstream of the collar section. The invention is characterized by the fact that the at least one axially extending channel is dimensioned in such a way that pressure medium may accumulate on the collar section.

The present invention relates to a pressure valve according to the preamble of claim 1.

Pressure valves, in particular pilot-actuated 2-way or 3-way pressure-relief valves, are used in hydraulic control engineering when a pressure at a consumer connection should be held as constant as possible, in accordance with a requirement. Areas of application are, e.g., hydraulic presses, clamping devices on machine tools, etc. In deviation from the requirement to hold a pressure constant given nearly any flow rate, actual pressure-relief valves have at least one decreasing regulating characteristic curve, i.e., as the flow rate increases, the control pressure decreases, while the preset pressure is held constant. This behavior is ascribed to the flow forces that act on the control plunger in the closing direction as the flow rate increases.

The characteristic curve of housing valves could be improved and the design of the valve could be simplified by tapping control pressure medium from a cavity in the control plunger of the valve. The controlled pressure is already present in this cavity. By tapping control pressure medium on the end face of the cavity, a favorable control pressure medium characteristic curve is attained, and the control plunger is prevented from closing at high flow rates. This valve design is disclosed in DE 196 15 789 A1.

In the case of pressure valves, efforts are made to make the design as cost effective as possible, and to reduce the type variety by providing a broad spectrum of uses. For this reason, pressure-relief valves in particular are being designed to an increasing extent as screw-in valves for use in stationary hydraulics and mobile hydraulics. A generic pressure valve of this type is presented, e.g., in data sheet RD 18111-02/06.05 from Bosch Rexroth AG.

The present invention is directed to describing a pressure valve having a screw-in valve design that is improved in terms of its control pressure characteristic curve.

This object is achieved via a pressure valve having the features of claim 1.

According to the present invention, a pressure valve is equipped with a valve bush and a control plunger which is movably guided in the valve bush, and it enables a pressure medium path from a pressure medium source to a consumer via the valve bush to be controlled. A collar section is provided on the control plunger, via which the cross section of a radial opening of the valve bush on the side of the pressure medium source may be modified. The pressure medium path downstream of the radial opening is guided by at least one channel which extends axially through the collar section. The pressure valve also comprises a pilot control system which is used to apply an adjustable control pressure to the control plunger; a control pressure medium supply channel comprising an inlet opening is provided on the control plunger in a region upstream of the collar section.

The invention is characterized by the fact that the at least one axially extending channel is dimensioned in such a way that pressure medium may accumulate on the collar section. In this manner, the inlet pressure at the control pressure medium supply channel may be increased as a function of an increasing flow rate. As a result, it is possible to influence the control pressure which is applied to the control plunger in the control pressure chamber in the sense of a linearization of the pressure medium quantity—control pressure characteristic curve. The particularly simple design of the valve should also be emphasized. As compared to conventional valves, the main difference is that the control plunger has been modified. It may be designed as a simple cylindrical body or as a stepped plunger. A simple, cost effective ability to manufacture a pressure valve according to the present invention is therefore ensured, while ensuring excellent constant-pressure behavior.

Advantageous embodiments of the present invention are presented in the dependent claims.

According to a preferred development, the control plunger is designed as a stepped plunger and extends axially starting from the first, aforementioned collar section into a radially recessed neck section and finally into a second collar section. A control plunger of this type is easy to manufacture and makes it possible to manufacture the channels required using simple bores.

Preferably, the control plunger is guided in the valve bush at both collar sections, thereby attaining a good seal and reliable functionality.

According to a particularly preferred development of the present invention, the control pressure medium supply channel extends away from an axially oriented surface of the second collar section or from a region of the neck section, in particular the jacket surface, close to the second collar section. This ensures that the pilot control system is reliably supplied with control pressure medium from a region in which constant pressure conditions exist.

The spectrum of use of the pressure valve according to the present invention is broader when it is designed as a 3-way valve; according to an advantageous design, the second collar section controls a cross section of a radial opening of the valve bush that is connected to a relief line.

According to a particularly preferred design, a second control pressure medium supply channel is provided, which includes an inlet opening on a side of the first collar section facing away from the neck section. This ensures that the pilot control system is reliably supplied with control pressure medium even in a pressure-limiting mode, in which pressure medium is directed from the consumer connection toward the tank.

A non-return valve is preferably located in the second control pressure medium supply channel, which, in accordance with its flow direction, permits pressure medium to enter the inlet opening of the second control pressure medium supply channel. In the pressure-relief mode, in which pressure medium is supplied to the consumer from the pressure medium source, the non-return valve prevents control pressure medium from flowing into the second control pressure medium supply channel, due to the pressure conditions. In this case, control pressure medium is supplied only through the first control pressure medium supply channel, thereby retaining the desired dependence of the control pressure medium supply quantity on the flow rate through the valve.

The two control pressure medium supply channels are particularly easy to manufacture when the second control pressure medium supply channel empties into the first control pressure medium supply channel. Preferably, a bore extending axially through the control plunger is provided in sections in order to form the first control pressure medium supply channel and the second control pressure medium supply channel. It is also advantageous when the inlet opening of the first control pressure medium supply channel is formed through a radial bore that empties into the axial bore.

According to a particularly preferred embodiment, several continuous axial bores are situated around the circumference of the collar section that empty into an annular surface of the collar section facing the neck section. In this design, the overall cross section of the channels may be specified very exactly by the first collar section. In addition, a large inflow chamber for the pressure medium supply may be formed on the neck section via the radial opening of the valve bush. This makes it possible to locate the opening of the control pressure medium supply channel at an adequate distance away from the control edge on the first collar section. Control pressure medium is withdrawn from a region having quiet flow. The pressure conditions that exist at the opening of the control pressure medium supply channel are independent, in particular, of the angular position of the control plunger.

The pressure valve is particularly simple in terms of design and it is cost-effective to manufacture when a continuous radial bore is formed in the neck section, and when an axial bore which empties into the radial bore is provided in the first collar section. According to the present invention, the diameter of the axial bore is selected to be less than the diameter of the radial bore.

According to a particularly preferred embodiment, the pilot control system causes the control pressure to rise when the quantity of control pressure medium supplied to it increases. In this manner, the flow forces acting in the closing direction may be compensated for directly. The pilot control system preferably includes a directly actuated pressure-limiting valve. A pressure-limiting valve of this type is cost effective and has the desired characteristic curve.

The present invention and its advantages are described in greater detail below with reference to the exemplary embodiments presented in the figures.

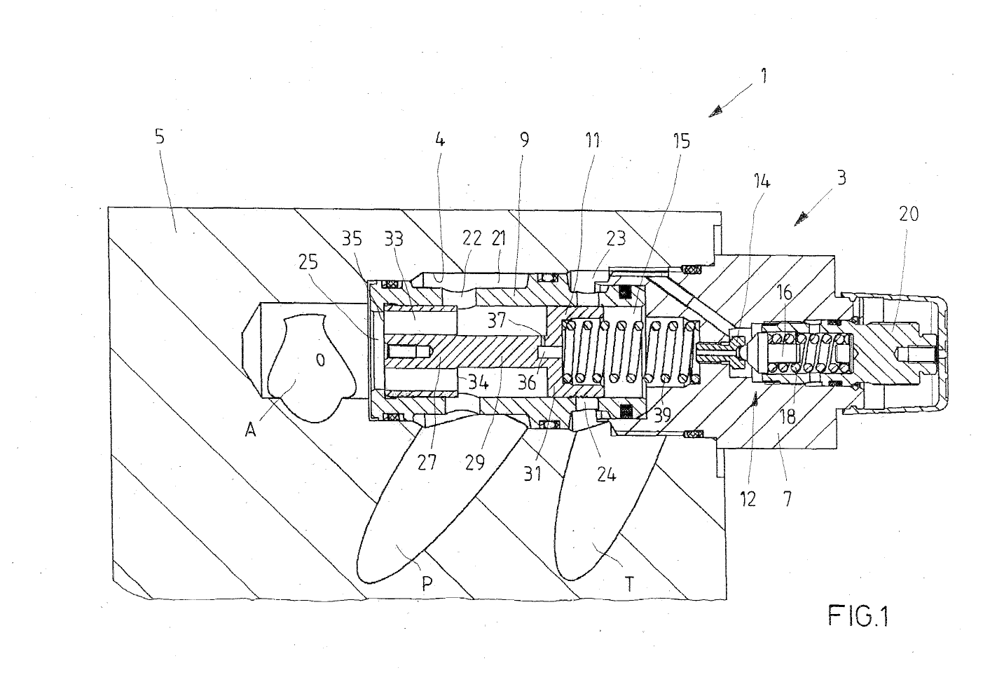

FIG. 1 shows a cross-sectional view of a pressure valve including a stepped control plunger and axial bores located in a ring formation in the collar section of the control plunger on the side of the consumer connection,

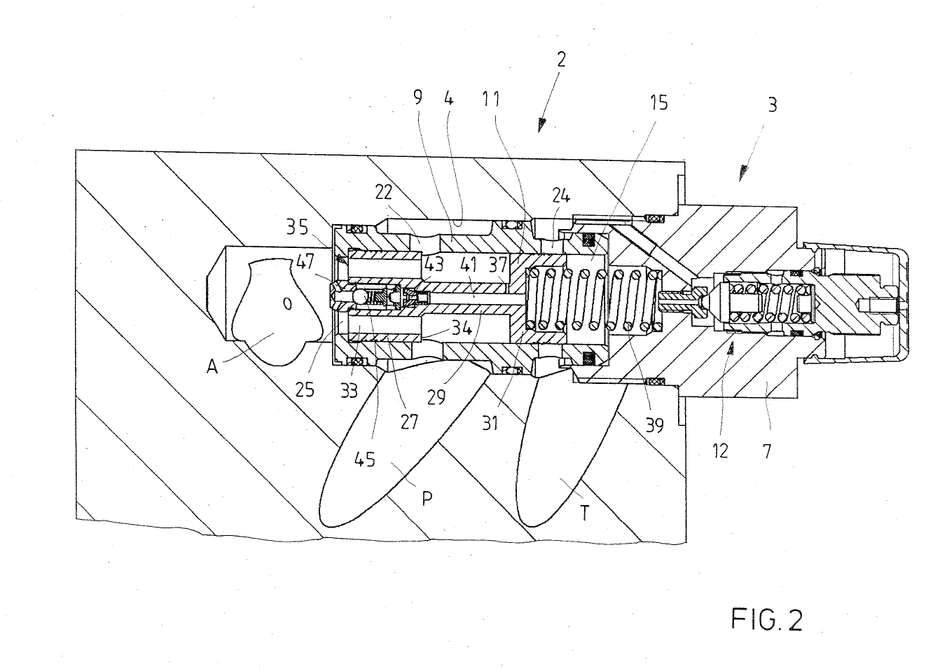

FIG. 2 shows a variant of a pressure valve corresponding to FIG. 1, in the case of which the control plunger in the end face on the consumer connection side includes an additional control pressure medium inlet opening,

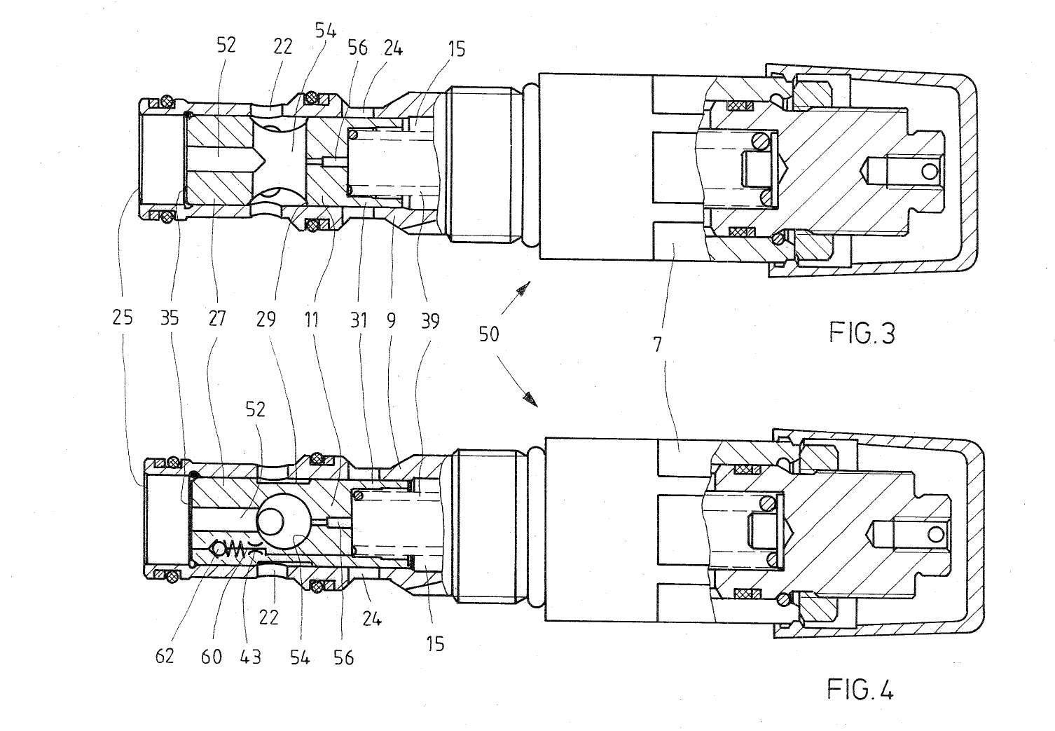

FIG. 3 shows a cross-sectional view of a pressure valve according to a further embodiment of the present invention, in which the control plunger includes a radial bore located in the pressure medium path, and an axial bore, and

FIG. 4 shows a cross-sectional view of the pressure valve shown in FIG. 3, rotated by 90°.

As shown in FIG. 1, a 3-way pressure-relief valve 1 is designed as a screw-in valve 3 which is provided for installation in a fitting bore 4 of a valve block 5. Valve block 5 includes connection bores which empty into fitting bore 4 and are assigned to a pressure medium source connection P, a tank connection T, and a consumer connection A of valve 1. Screw-in valve 3 includes, as usual, a fastening sleeve 7 and a valve bush 9 which is retained in fastening sleeve 7 and in which a control plunger 11 is movably guided.

A pilot valve is located in fastening sleeve 7. The pilot valve is designed as a pressure-limiting valve 12 having a poppet valve design. The fluidic connection to a control pressure chamber 15 is given via a seat sleeve 14 provided with a damping nozzle. A control cone 16 is acted upon by a compression spring 18 with a force in the direction of seat sleeve 14. The opening pressure of pressure-limiting valve 12 may be adjusted using adjusting sleeve 20 which acts on compression spring 18.

Valve bush 9 includes a first ring of radial bores 22 that are located in a pressure medium supply region 21 of fitting bore 4, and a second ring of radial bores 24 that are located in a tank connection region 23 of fitting bore 4. End-face opening 25 of the valve bush is fluidically connected to consumer connection A. Control plunger 11 guided in valve bush 9 is axially subdivided into a first collar section 27 facing opening 25, a neck section 29, and a second collar section 31 which limits control pressure chamber 15. First collar section 27 includes a ring of axially situated bores 33 which empty into an annular surface 34 facing neck section 29. Second collar section 31 is provided with a recess on its side facing control pressure chamber 15. An axial bore 36 at the base of the recess is designed as a blind hole. Together with a nozzle bore 37 formed radially in neck section 29 in the immediate vicinity of second collar section 31, axial bore 36 forms a second control pressure medium supply channel for control pressure chamber 15. A compression spring 39 is accommodated in control pressure chamber 15 that bears against the base of the recess of second collar section 31 and an annular surface of fastening sleeve 7. Compression spring 39 acts on the control plunger with a force directed toward opening 25.

The functionality of pressure-relief valve 1 shown in FIG. 1 will be described below. The pressure that exists in consumer connection A is established via a force equilibrium condition at control plunger 11. When pressure medium flows from P to A, control plunger 11 assumes a position in which an equilibrium of forces acting to close radial bores 22 and to open radial bores 22 prevails. These are the hydrostatic forces applied by consumer connection A, the force caused by the control pressure in control pressure chamber 15, and the force of compression spring 39. Control plunger 11 therefore controls the pressure in consumer connection A in accordance with the preset control pressure and the force of compression spring 39 which, however, is typically selected to be small. When pressure medium flows from A to T, the force equilibrium described above also exists. Control plunger 11 assumes a position in which it controls an outflow of pressure medium at radial bores 24. In this direction of pressure medium flow, the pressure in consumer connection A is limited in accordance with the control pressure and the force of compression spring 39.

When the pressure medium flows from P to A, the restriction of the flow cross section at axial bores 33 results in a pressure differential across first collar section 27. The pressure medium becomes “jammed” upstream of first collar section 27. The increase in pressure on the neck side of control plunger 11 compared to consumer connection A is that much higher, the greater the quantity is of flowing pressure medium. If the pressure at neck section 29 of control plunger 11 is higher, then the quantity of control pressure medium flowing through nozzle bore 37 and into control pressure chamber 15 increases. Due to the increasing control pressure medium quantity—control pressure characteristic curve of pressure-limiting valve 12, the control pressure in control pressure chamber 15 increases in addition to the quantity of pressure medium flowing along the path from P to A. The increased control pressure increases the force acting on control plunger 11 in the sense of opening radial bores 22. This counteracts the flow forces that act in the closing direction and increase as the quantity of pressure medium increases. In this manner it is possible to attain a nearly constant pressure medium quantity—control pressure characteristic curve of pressure-relief valve 1.

A person skilled in the art who has knowledge of the present invention determines the required cross section of axial bores 33 and the required increase in the control pressure medium quantity—control pressure characteristic curve of pressure-limiting valve 12 using common calculations or experiments.

The present invention may also be used directly with 2-way pressure-relief valves, of course. A 2-way pressure-relief valve of this type may be attained simply by eliminating the tank connection and associated radial bores 24. This does not affect the compensation of the flow forces in flow direction P to A described above.

A variant of pressure-relief valve 1 shown in FIG. 1 is presented in FIG. 2 using 3-way pressure-relief valve 2. Its design corresponds most closely to the design of pressure-relief valve 1. The only difference between the two is the supply of control pressure medium. The same reference numerals are used for the same features. In the description of pressure-relief valve 2 that follows, only the stated differences from pressure-relief valve 1 are indicated.

In contrast to axial bore 36 which is designed as a blind hole, in the case of control plunger 11 of pressure-relief valve 2, a stepped axial bore 41 is present that extends through control plunger 11 along its entire length. Nozzle bore 37 empties into axial bore 41 in the direct vicinity of the shoulder of second collar section 31. The following are located one after the other in stepped axial bore 41 in the direction toward end face 35 of control plunger 11 facing opening 25 of valve bush 9: a nozzle insert 43, a non-return valve 45, and an inlet adapter piece 47 at the mouth opening of axial bore 41.

In the pressure-relief mode, when the pressure medium flows from P to A, the pressure in the region of neck section 29 is somewhat higher, due to the constriction of the pressure medium path through axial bores 33, than the pressure is at consumer neck A, i.e., than at inlet adapter piece 47. Non-return valve 45 therefore remains closed. Control pressure medium is supplied to control pressure chamber 15 only via nozzle bore 37. Non-return valve 45 prevents an outflow of control pressure medium in the direction of end face 35. The desired increase in the control pressure medium quantity is attained with the pressure medium quantity delivered via the valve.

In contrast, in the pressure-limiting mode, when the pressure medium flows from A to T, the pressure at inlet adapter piece 47 is higher than the pressure at nozzle bore 37. Non-return valve 45, which includes a very weak spring, opens and permits the inflow of control pressure medium into control pressure chamber 15 from the region in front of end face 35 of control plunger 11. If the pressure differential across first collar section 27 is high, it would no longer be possible to supply an adequate quantity of control pressure medium soley via nozzle bore 37, which could result in a worsening of the pressure-limiting function or, in the worst case, an interruption in the supply of control oil and an abrupt drop in the pressure maintained at connection A. The reliable supply of control pressure medium is ensured via the inflow of control pressure medium from the region in front of end face 35 at which a higher pressure accumulates, as stated. The quantity of control pressure medium supplied via inlet adapter piece 47 may be established via the inner diameter of nozzle insert 43.

A further embodiment of the present invention is presented in FIGS. 3 and 4 using 3-way pressure-relief valve 50. The illustration in FIG. 4 is rotated about the valve axis by 90° as compared to the depiction in FIG. 3. Pressure-relief valve 50 is designed as a screw-in valve, as in the first embodiment. 3-way pressure-relief valve 50 differs from pressure-relief valve 2 described above only in terms of the design of control plunger 11. The same reference numerals are used for the same features. In the description of pressure-relief valve 50 that follows, only the stated differences from pressure-relief valve 2 are indicated.

Control plunger 11, as a stepped plunger, is provided with a first collar section 27 which faces valve bush opening 25, a neck section 29, and a second collar section 31 which faces control pressure chamber 15. The pressure in control pressure chamber 15 is adjusted using a pilot valve (not depicted), preferably a pressure limiting valve located in fastening sleeve 7.

In contrast to pressure-relief valve 1 or 2, neck section 29 of control plunger 11 of pressure-relief valve 50 is recessed only slightly in the radial direction, and so it may also be regarded as a circumferential groove in the jacket surface of control plunger 11. Neck section 29 is penetrated by a radial bore 54, the diameter of which almost corresponds to the width of neck section 29. Instead of a ring of axially positioned bores 33, only one centrally located axial bore 52 is present that starts at end face 35 and empties into radial bore 54. The diameter of axial bore 52 is less than the diameter of radial bore 54. A further, stepped axial bore forms control pressure medium supply channel 56 in second collar section 31. The end section of control pressure medium supply channel 56 facing radial bore 54 is designed as a nozzle bore.

As shown in FIG. 4, an additional control pressure medium supply channel 60 is provided in the jacket of control plunger 11. It is provided with a nozzle insert 43 and a non-return valve 62 which permits an inflow of control pressure medium into control pressure chamber 15 from end face 35 under certain pressure conditions. Control pressure medium supply channel 60 is preferably designed as a stepped axial bore.

The functionality of pressure-relief valve 50 corresponds to the functionality of pressure-relief valve 2. When pressure medium flows from P to A, in the pressure-relief mode, the constriction of the cross section of axial bore 52 results in a pressure differential across first collar section 27. Pressure medium accumulates upstream of first collar section 27 in the region of neck section 29. The pressure differential increases as the quantity of pressure medium increases. As the pressure medium quantity increases, the pressure present at the inlet opening of control pressure medium supply channel 56 increases, and, therefore, so does the quantity of control pressure medium that is supplied. Via the increasing control pressure characteristic curve, the above-described compensation of flow forces acting on control plunger 11 is made possible, thereby resulting in a nearly constant pressure medium quantity—control pressure characteristic curve of pressure-relief valve 50. Non-return valve 62 remains closed in this direction of pressure medium flow.

When pressure medium flows from A to T—in the pressure-limiting mode—control pressure medium supply channel 60 which also includes non-return valve 62 makes it possible for control pressure chamber 15 to be reliably supplied with control pressure medium. This applies in particular to high pressure medium flows from A to T, in the case of which it would not be possible to supply pressure medium reliably soley via control pressure medium supply channel 56 due to the pressure differential that forms across first collar section 27.

The present invention should also contain combinations of features from the first embodiment with features from the second embodiment. For example, pressure-relief valve 50 may be designed directly as a 2-way pressure-relief valve by eliminating radial bores 24. It is then possible to eliminate additional control pressure medium supply channel 60 which includes non-return valve 62 and nozzle insert 43, similar to the embodiment shown in FIG. 1. A 3-way pressure-relief valve 50 may definitely also be designed without additional control pressure medium supply channel 60, non-return valve 62, and nozzle insert 43 by limiting the maximum volume to be delivered toward the tank, or by only slightly constricting the flow path through axial bore 52.

### LIST OF REFERENCE NUMERALS

1 Pressure-relief valve
2 Pressure-relief valve
3 Screw-in valve
4 Fitting bore
5 Valve block
7 Fastening sleeve
9 Valve bush
11 Control plunger
12 Pressure-limiting valve
14 Seat sleeve
15 Control pressure space
16 Control cone
18 Compression spring
20 Adjusting sleeve
21 Pressure medium supply region
22 Radial bores
23 Tank connection region
24 Radial bores
25 Opening
27 First collar section
29 Neck section
31 Second collar section
33 Axial bores
34 Annular surface
35 End face
36 Axial bore
37 Nozzle bore
39 Compression spring
41 Axial bore
43 Nozzle insert
45 Non-return valve
47 Inlet adapter piece
50 Pressure-relief valve
52 Axial bore
54 Radial bore
56 Control pressure medium supply channel with nozzle bore
60 Control pressure medium supply channel
62 Non-return valve
A Consumer connection
P Pressure medium source connection
T Tank connection

What is claimed is:

1. A pressure valve comprising a valve bush (9) and a control plunger (11) which is movably guided in the valve bush (9) and enables a pressure medium path from a pressure medium source to a consumer via the valve bush (9) to be controlled; a collar section (27) is provided on the control plunger (11), via which the cross section of a radial opening (22) of the valve bush (9) on the side of the pressure medium source may be modified; the pressure medium path downstream of the radial opening (22) is guided by at least one channel (33; 52) extending axially through the collar section (27); the pressure valve also comprises a pilot control system (12) which is used to apply an adjustable control pressure to the control plunger (11); a control pressure medium supply channel (36, 37; 56) comprising an inlet opening is provided on the control plunger (11) in a region upstream of the collar section (27),
wherein
the at least one axially extending channel (33; 52) is dimensioned in such a way that pressure medium may accumulate on the collar section (27).

2. The pressure valve as recited in claim 1,
wherein
the control plunger (11) is designed as a stepped plunger and extends axially starting from the first, aforementioned collar section (27) into a radially recessed neck section (29) and finally into a second collar section (31).

3. The pressure valve as recited in claim 2,
wherein
the control plunger (11) is guided at both collar sections (27, 31) in the valve bush (9).

4. The pressure valve as recited in claim 2,
wherein
the control pressure medium supply channel (36, 37; 56) extends away from an axially oriented surface of the second collar section (31) or from a region of the neck section (29), in particular the jacket surface, in the vicinity of the second collar section (31).

5. The pressure valve as recited in claim 2,
wherein
the second collar section (31) controls a cross section of a radial opening (24) of the valve bush (9) that is fluidically connected to a relief line.

6. The pressure valve as recited in claim 5,
wherein
a second control pressure medium supply channel (41; 60) is provided, which includes an inlet opening on a side of the first collar section (27) facing away from the neck section (29).

7. The pressure valve as recited in claim 6,
wherein
a non-return valve (45; 62) is located in the second control pressure medium supply channel (41; 60), which, in accordance with its flow direction, permits pressure medium to enter the inlet opening of the second control pressure medium supply channel (41; 60).

8. The pressure valve as recited in claim 7,
wherein
the second control pressure medium supply channel empties into the first control pressure medium supply channel.

9. The pressure valve as recited in claim 8,
wherein
a bore (41) extending axially through the control plunger (11) is provided in sections in order to form the first control pressure medium supply channel and the second control pressure medium supply channel.

10. The pressure valve as recited in claim 9,
wherein
the inlet opening of the first control pressure medium supply channel is formed by a radial bore (37) which empties into the axial bore (41).

11. The pressure valve as recited in claim 1,
wherein
several continuous axial bores (33) are situated around the circumference of the collar section (27) that empty into an annular surface (34) of the collar section (27) facing the neck section (29).

12. The pressure valve as recited in claim 2,
wherein
a continuous radial bore (54) is formed in the neck section (29), an axial bore (52) which empties into the radial bore (54) is provided in the first collar section (27), and the diameter of the axial bore (52) is less than the diameter of the radial bore (54).

13. The pressure valve as recited in claim 1,
wherein
the pilot control system (12) causes the control pressure to increase when the quantity of control pressure medium supplied to it increases.

14. The pressure valve as recited in claim 1,
wherein
the pilot control system includes a directly actuated pressure-limiting valve (12).
